(19) United States
(12) Patent Application Publication
(10) Pub. No.: US 2019/0128404 A1
(43) Pub. Date: May 2, 2019

(54) LINEAL SHIFTER ASSEMBLY WITH MULTI-POINT GUIDING

(71) Applicant: Dura Operating, LLC, Auburn Hills, MI (US)

(72) Inventors: Alberto Polonio Morales, West Bloomfield, MI (US); Dale A. Beattie, Norton Shores, MI (US)

(21) Appl. No.: 15/800,530

(22) Filed: Nov. 1, 2017

(51) Int. Cl. F16H 59/10; F16H 61/24

(52) U.S. Cl. CPC F16H 59/105; F16H 2059/026; F16H 61/24

(57) ABSTRACT

In at least some implementations, a vehicle shifter assembly includes a first guide having an axis, a shift lever coupled to the first guide for two-way movement of the shift lever along the first guide in a path parallel to the first axis, and a second guide spaced from the first guide and engageable with the shift lever to limit rotational movement of the shift lever relative to the first guide about the axis. In at least some implementations, the shift lever includes a main body with an opening through which the first guide extends.

### TECHNICAL FIELD

The present disclosure relates to a vehicle shifter assembly such as may be used to shift among gears of a vehicle transmission.

### BACKGROUND

In some vehicles, a gear shift lever in a passenger compartment of the vehicle can be moved by an operator of the vehicle to shift the vehicle transmission between its park gear and other gears, such as reverse, neutral and forward drive gears. The shift lever is mechanically coupled to the transmission through a cable that transmits the shift lever movement to a transmission shift mechanism.

Other vehicles use a so-called “shift-by-wire” system wherein an operator shift lever or shift control unit is not physically coupled to the transmission shift mechanism by a cable. Instead, the shift control unit is electrically coupled to a shift actuator that is arranged to shift the transmission upon receipt of a signal from the shift control unit that a transmission gear shift is desired by the operator. In these systems, the position of the shift lever does not necessarily correspond to the currently selected transmission gear.

### SUMMARY

In at least some implementations, a vehicle shifter assembly includes a first guide having an axis, a shift lever coupled to the first guide for two-way movement of the shift lever along the first guide in a path parallel to the first axis, and a second guide spaced from the first guide and engageable with the shift lever to limit rotational movement of the shift lever relative to the first guide about the axis. In at least some implementations, the shift lever includes a main body with an opening through which the first guide extends.

In at least some implementations, the second guide includes a first guide surface and a second guide surface that are arranged so that the shift lever engages the first guide surface when the shift lever is acted upon by a force tending to rotate the shift lever in a first direction about the axis, and the shift lever engages the second guide surface when the shift lever is acted upon by a force tending to rotate the shift lever in a second direction about the axis. The shift lever may include a roller that rolls along the first guide when the shift lever is moved along the path. In addition to or instead, the shift lever may include a roller that engages the second guide.

In at least some implementations, a position sensor having a sensor is positioned adjacent to the shift lever path of movement and a sensed component is carried by the shift lever and moved relative to the sensor. In this way, the position of the shift lever can be determined to facilitate commands to shift the transmission.

In at least some implementations, the assembly includes a housing having an interior in which is received at least part of the shift lever, and the housing may include a plurality of feedback features and a coupler may be carried by the shift lever for movement with the shift lever relative to the feedback features. The coupler may be responsive to the feedback features to provide force feedback to the shift lever. The feedback features may include a surface having a plurality of peaks and valleys and the coupler may engage the surface and move relative to the shift lever in response to movement of the coupler over the peaks and valleys.

In at least some implementations, a vehicle shifter assembly, includes a first guide having an axis; a shift lever and a second guide. The shift lever includes a first end, a second end, and a coupling feature between the first end and the second end that couples the shift lever to the first guide, the coupling feature overlaps at least a portion of the first guide and permits two-way movement of the shift lever along a path defined by the first guide. The second guide is spaced from the first guide and engageable with the shift lever. The first guide and coupling feature limit rotation of the shift lever relative to the first guide along a plane including the axis, and the second guide constrains movement of the shift lever relative to the first guide about the axis in a plane perpendicular to the axis.

### BRIEF DESCRIPTION OF THE DRAWINGS

The following detailed description of representative implementations and best mode will be set forth with regard to the accompanying drawings, in which:

FIG. 1 is a perspective and partially sectioned view of a shift lever assembly;

FIG. 2 is an enlarged sectional view of the shift lever assembly;

FIG. 3 is another enlarged sectional view of the shift lever assembly showing a coupler for a force feedback arrangement;

FIG. 4 is another enlarged sectional view of the shift lever assembly taken at a different angle than in FIGS. 1 and 2;

FIG. 5 is a diagrammatic view illustrating an arrangement of shift lever positions or stations;

FIG. 6 is a perspective sectional view of a shift lever assembly;

FIG. 7 is an enlarged sectional view of a portion of the shift lever assembly;

FIG. 8 is a perspective view of first and second guides and first and second rollers associated with the guides; and

FIG. 9 is an enlarged sectional view of a portion of the shift lever assembly showing a return actuator.

### DETAILED DESCRIPTION

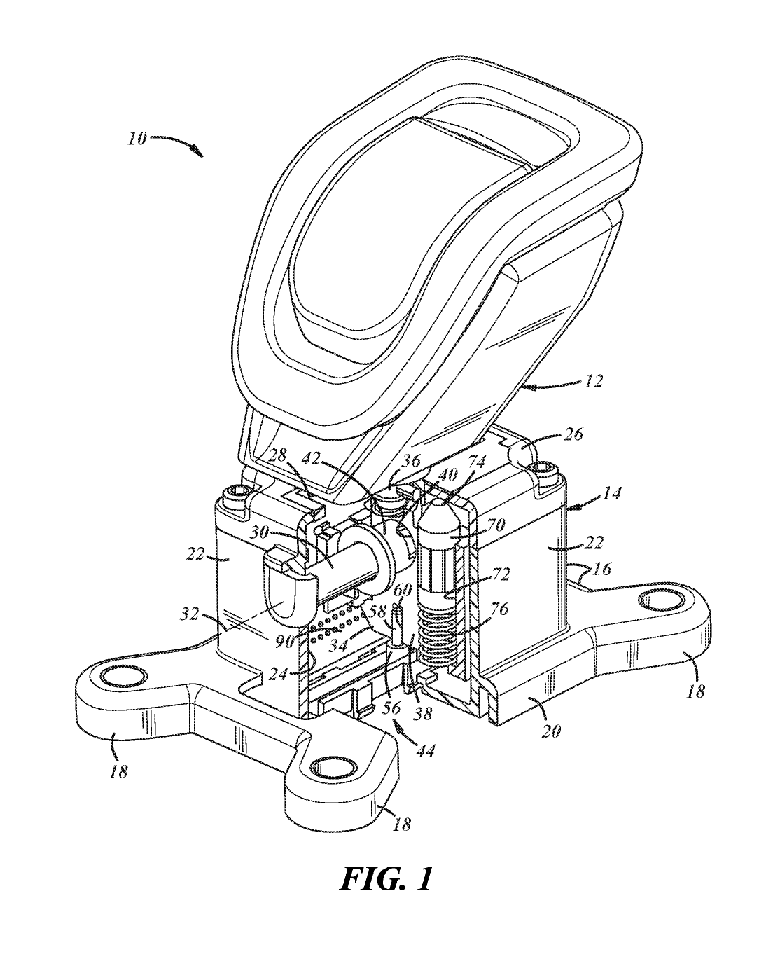

Referring in more detail to the drawings, FIG. 1 shows a vehicle shifter assembly 10 that may be used to change a mode of a vehicle transmission (e.g. cause a transmission gear change). The assembly 10 includes a gear shift lever 12 that may be moved by a driver of the vehicle to shift the transmission among various modes, typically including park, neutral, reverse and forward drive gears. The shifting system of which the shifter assembly 10 is a part may be a so-called “shift by wire” system where an operator command for a gear shift is electrically transmitted to a transmission shift actuator that is coupled to a shift mechanism of the transmission to cause the actuator to shift the transmission.

In at least some implementations, the shift lever assembly 10 may include a housing 14 and the shift lever 12 may be carried by the housing for movement relative to the housing. The housing 14 may include a base 16 that may be fixed to the vehicle, such as by bolts received through holes in mounting flanges 18 of the base. The base 16 may include an end wall 20 and one or more side walls 22 extending from the end wall and defining an at least partial enclosed interior 24 in which some components of the shift lever assembly 10 may be received. The housing 14 may include a cover 26 fixed to the base 16, for example, to the walls 22 at a location spaced from the end wall 20. The cover 26 may further define the interior 24, and may include an opening 28 through which part of the shift lever 12 extends into the interior. A first guide 30 may be formed in and/or carried by the housing 14, and may be received partially or fully within the interior 24. In at least some implementations, the guide 30 is a straight component that has an axis 32 along which the shift lever 12 moves in a linear fashion. The guide 30 may be a rod, rail or component to which the shift lever 12 is slidably coupled for movement in two, opposite directions (e.g. fore and aft). The guide 30 may be carried by the housing 14, and in at least some implementations, may be trapped between the cover 26 and surfaces of one or more side walls 22 of the housing base 16. The shift lever 12 is moved (e.g. pushed or pulled) along the guide 30 by a vehicle driver to cause a transmission shift as described in more detail below.

The shift lever 12 may include a main body 34 having a first end 36 that may be located outboard of the housing interior 24 and a second end 38 received within the housing interior. The shift lever 12 is slidably coupled to the guide 30 between its ends 36, 38, or at or near its second end 38. In at least some implementations, the shift lever body 34 is a one-piece body that has various features defined within a single piece of material, or in multiple pieces of materials that are joined together in the process of forming the shift lever body (e.g. a metal component overmolded by plastic, where the molding process forms the shift lever body and the metal and plastic portions are integrally coupled together). Of course, multi-piece shift lever bodies may be used, if desired.

The main body 34 includes or otherwise carries a coupling feature 40 for slidably coupling the main body to the guide 30. In the implementation shown in FIGS. 1-4, the coupling feature includes an opening 40 through the main body 34, where the guide 30 extends through the opening. If desired, a reduced friction interface may be provided between the main body 34 and the guide 30, such as by providing a bearing 42 within the opening 40, or the guide may include a bearing surface or other reduced friction interface along which the main body slides (e.g. roller balls along one or more surfaces of the guide, a reduced friction strip, surface, rail or coating—e.g. Teflon). In at least some implementations, a relatively close fit is provided between the main body 34 and the guide 30 (and/or any bearing(s) between them) to reduce “play” or wiggling of the main body relative to the guide. The coupling feature 40 may have a certain minimum axial length to inhibit or prevent rotation of the main body 34 relative to the guide 30 in a plane parallel to and including the axis 32 of the guide 30.

The assembly 10 may further include a second guide 44 arranged to resist movement of the main body 34 about the axis 32 of the first guide 30, e.g. in a plane perpendicular to the axis of the first guide. In implementations wherein the first guide 30 has a circular cross-section, the main body 34 may tend to rotate about the axis 32 and relative to the first guide in a plane perpendicular to the axis of the first guide. The second guide 44 may be positioned to inhibit or prevent such movement of the main body 34 relative to the first guide 30 in one or both directions of rotation (e.g. clockwise and/or counterclockwise when viewed from an end of the first guide).

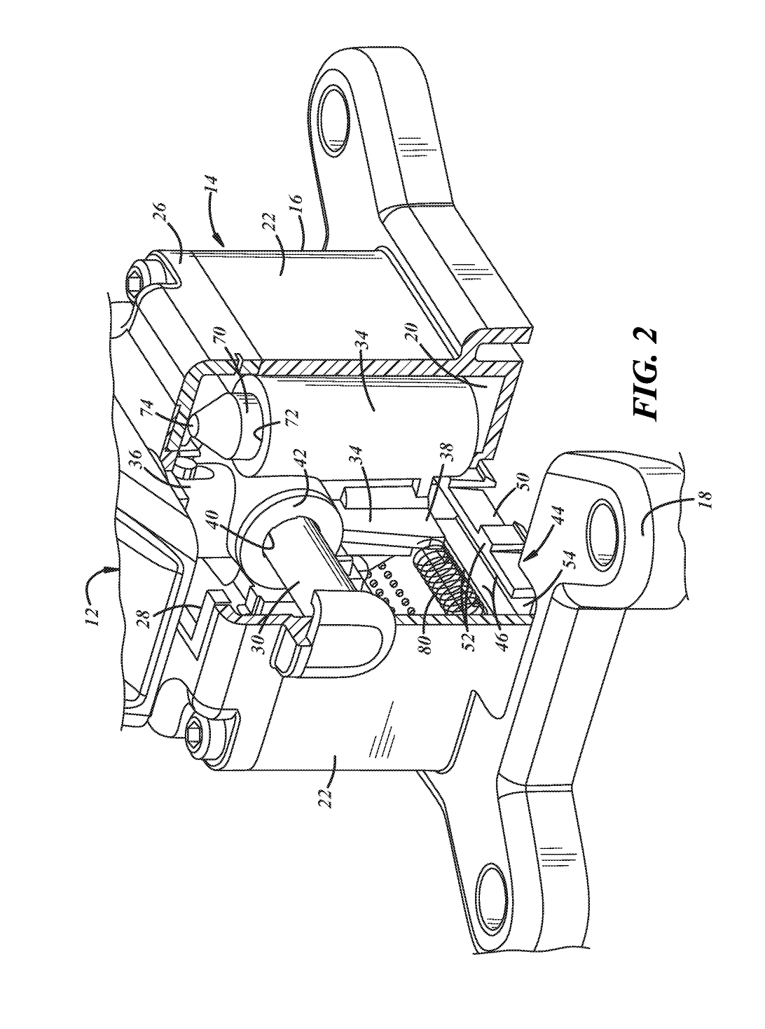

In this way, the second guide 44 may include one or more guide surfaces 46 that is/are radially spaced from the axis 32 of the first guide 30, parallel to the axis of the first guide and laterally offset from and engageable with a portion of the main body 34. In this example, lateral means to the side of the portion of the main body 34, outboard of the path of movement of that portion of the main body as the shift lever 12 is moved to cause a transmission shift. Hence, the second guide 44 has at least one surface 46 that extends parallel to and is laterally outboard of the path of movement of a portion of the main body 34. The second guide 44 may include or be defined by a surface of the housing 14, for example, a surface formed in the base 16, may be defined in or by a slot formed in the base (e.g. the end wall 20), or by a component (e.g. an insert) carried by the housing. In the example shown in FIGS. 2 to 4, the second guide 44 is defined by a channel 50 carried by the base 16. The channel 50 has a pair of parallel side walls 52 that are spaced apart and having oppositely facing inner surfaces that define the guide surfaces 46 adapted to engage part of the shift lever 12 to limit movement of the shift lever. The side walls 52 may be interconnected by a base 54.

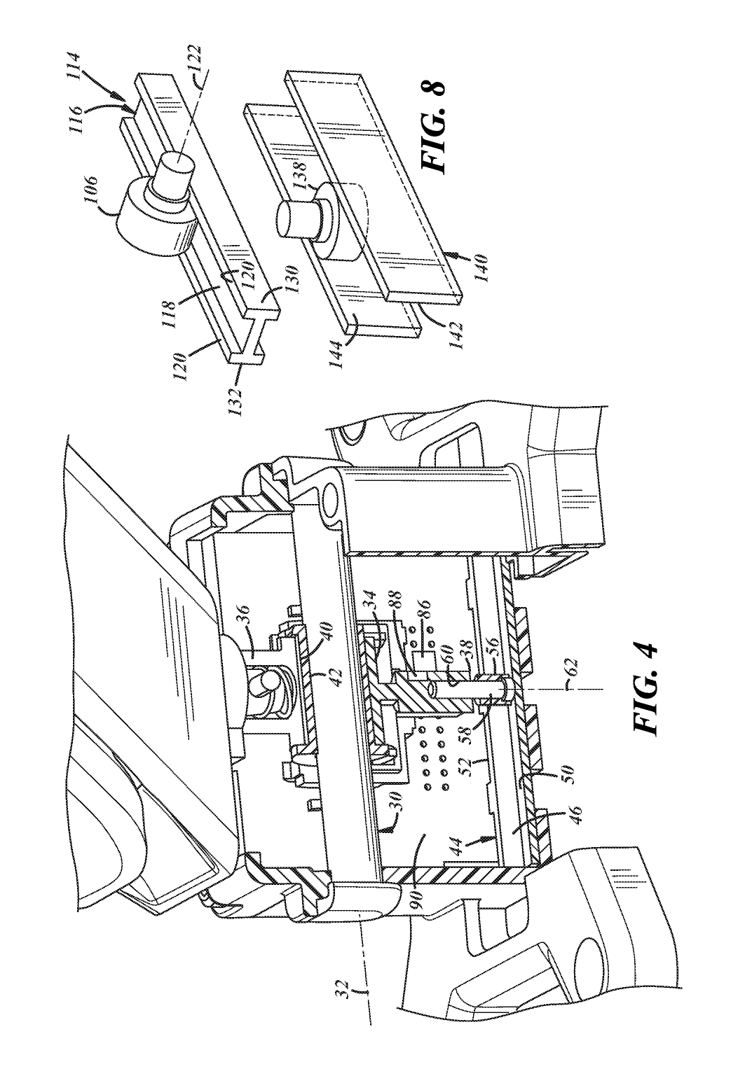

The main body 34 of the shift lever 12 and/or the second guide 44 may include a reduced friction interface which may include a bearing or reduced friction surfaces of one or both of the guide 44 and adjacent portion of the main body 34. In the implementation shown, the shift lever 12 includes, and the main body 34 carries, a roller 56 that is received between two, oppositely facing guide surfaces 46 of the second guide 44. The oppositely facing guide surfaces 46 are each arranged to prevent rotation of the shift lever 12 toward either of the guide surfaces, to constrain the shift lever for movement along the axis 32 of the first guide 30. The roller 56 may rotate when engaged with either guide surface 46 to reduce friction or resistance to the sliding movement of the shift lever 12. The roller 56 may be carried on a pin 58 having an end received within a bore 60 in the main body 34, and the pin and/or roller may rotate about an axis 62 (FIG. 4) that is oriented generally perpendicularly to the axis 32 of the first guide 30. As a non-limiting example of other possible arrangements, the second guide 44 could include a single wall with opposed surfaces and the wall may be received within a slot formed in the main body 34 of the shift lever 12 so the shift lever moves along the wall like a rail. Rotation of the shift lever about the axis of the first guide is prevented by engagement of the main body 34 with the wall within the slot in the main body.

Hence, in an implementation wherein the shift lever is moved forward and backward to cause transmission shifts (where forward and backward are directions 180 degrees from each other) the shift lever is constrained against rotation or tipping movement forward or backward (i.e. in a plane parallel to the axis of the first guide) by the axial length of the coupling feature 40 on the first guide 30, and the shift lever is constrained against rotation laterally, generally perpendicular to the forward and backward directions by the second guide 44. In this way, movement of the shift lever 12 other than forward and backward is constrained to provide a generally linear path of movement of the shift lever relative to the housing 14.

The shift lever assembly 10 may also include one or more feedback features 66 that provide a tactile feel to the person moving the shift lever 12 (e.g. operator or driver) that the lever is moving from one position to the next, where the positions are each associated with a transmission gear. In this way, the operator can better control the number of positions that the shift lever 12 moves through to better control the selected transmission gear to which the transmission should be shifted. The feedback features 66 may replicate or provide forces on the shift lever 12 similar to the feeling or forces of shifting a mechanically linked shift lever among the various transmission gears.

In at least some implementations, the feedback features 66 are provided along an interior surface 68 of the housing 14, and the feedback features include a number of recesses or valleys 69 and ridges or peaks 71 between the valleys. Each valley 69 may define a position of the shift lever 12 that is associated with a transmission gear such that movement of the shift lever to the next position causes a transmission gear shift.

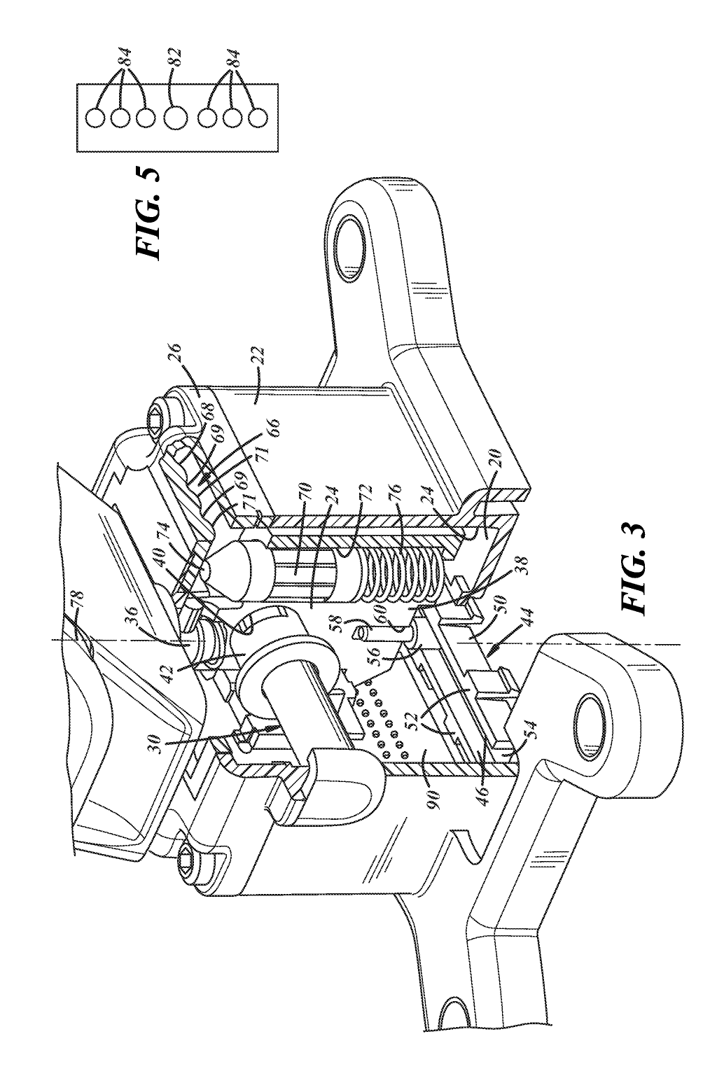

A coupler 70 may be carried by the main body 34 of the shift lever 12 so that the coupler moves relative to the feedback features 66 as the shift lever is moved. The coupler 70 may include a portion that is biased against interior surface 68 and rides from one valley, over a raised surface or peak, and into the next valley when the shift lever 12 is moved from one position to an adjacent position. In the implementation shown, the coupler 70 includes a pin (FIGS. 1, 2 and 4) that is carried by the shift lever 12, such as within a pocket or cavity 72 formed in the main body 34. The pin 70 has a free end 74 that is received against the interior surface 68 and is biased by a spring 76 received in the cavity 72 so that the pin 70 is urged out of the cavity and into engagement with the feedback features 66. The pin 70 moves relative to the cavity 72, against the force of the spring 76, as the pin encounters the feedback features 66 of varying height/dimension and the resulting forces on the shift lever 12 are noticeable to an operator moving the shift lever. In the implementation shown, the pin 70 is offset from an axis 78 (FIG. 3) of the shift lever 12, and also offset from the axis 32 of the first guide 30. In other implementations, the pin 70 could be axially aligned with one or both axes 32, 78. For example, the pin 70 could extend axially from an end of the shift lever 12, or the pin could define the second end 38 of the shift lever. Further, while the pin 70 is shown as extending upwardly toward a bottom facing interior surface 68 of the cover 26, the pin 70 could extend in other directions, such as horizontally, toward an inwardly facing interior surface of one of the walls 22. With regard to the feedback features, the peaks may extend further into the interior from the interior surface 68 of a wall 22 or cover 26 than do the valleys.

In a vehicle having Park, Reverse, Neutral and Drive modes or gears, the driver would expect to move through two positions (e.g. valleys) and into a third position to shift the vehicle transmission from park to drive, and vice versa, with these shifts occurring with movement of the shift lever 12 in opposite directions (e.g. forward and backward, up and down, or left and right, etc). A central position, in the implementation shown, may define a home position 82 of the shift lever.

In at least some implementations, the shift lever 12 is acted upon by an actuator 80 which provides a force on the shift lever tending to move the shift lever toward the home position 82. When a force moving the shift lever 12 to cause a transmission gear change is no longer applied to the shift lever, the actuator 80 returns the shift lever to the home position 82 (which is shown in FIGS. 1-3). This is a so-called monostable shifting arrangement, although other arrangements may be used including arrangements wherein the shift lever 12 is biased or movable to more than one position, or to a position other than a central position. In the implementation shown, the actuator 80 is a spring (diagrammatically shown in FIG. 2) or more than one spring that yieldably biases and move(s) the shift lever 12 back to the home position when an operator removes his or her hand from the shift lever, after moving the shift lever from the home position to cause a transmission gear shift.

Because the shift lever 12 may be moved in either direction from the home position to change the transmission mode, depending upon the current transmission mode and desired transmission mode, the home position 82 preferably is the middle or center most position. In the example shown in FIGS. 1-4, the shift lever assembly 10 has seven positions, although other assemblies may use 5 positions or some other number of positions. As shown in FIG. 5, the home position 82 is in the middle and three other positions 84 are provided on either side of the home position. Hence, if the vehicle transmission is in drive, the driver may wish to shift into park which would require moving the shift lever 12 in a first direction (e.g. forward) through neutral and reverse gears before reaching park, as in a traditional shift lever arrangement. Conversely, if the vehicle transmission is in park and the driver wishes to shift into drive, the shift lever 12 would be moved in a second direction (e.g. backward) through reverse and neutral before reaching drive. Thus, in a transmission having P, R, N and D modes, the maximum modes to shift through in either direction is three, so there are three positions on either side of the home position. Of course, other arrangements can be provided, as desired.

To facilitate returning the shift lever 12 to the home position, the peaks may be defined by ramped surfaces that are steeper on the side of each valley leading away from the home position and shallower on the sides of the valleys returning toward the home position. In this way, the engagement of the pin 70 with the ramped surfaces is less when the spring 80 is returning the shift lever 12 to the home position after a gear shift, but suitable feedback can be provided to the operator when the shift lever is moved by the operator away from the home position so the operator clearly feels the various positions through which the shift lever is moved. Of course, other implementations may be used, including implementations without any ramps, for example, just detents or cavities into which a spring biased coupler is releasably received. Of course, the shift lever 12 could be stable or positionable in more than one position and need not include the actuator and return function, as desired.

The linear movement of the shift lever 12 may simplify sensing the position and movement of the shift lever, to simplify and improve the reliability of electronically commanded transmission gear shifts. Compared to shift levers that are rotated about a pivot and have an arcuate path of movement, the linear path may be easier to sense with contact or non-contact type sensors. For example, with a magnetic sensing arrangement, a sensor 86 (FIG. 4) may be positioned laterally adjacent to the path of movement and a magnet 88 may be carried by the shift lever 12 for movement relative to the sensor. The distance between the magnet 88 and sensor 86 may remain constant which facilitates a determination of the magnet position relative to the sensor, and hence, the position of the shift lever 12. In the example shown, the sensor 86 is carried by a printed circuit board 90 that is received within the housing interior 24 and located adjacent to the first guide 30. The magnet 88 is carried by the shift lever main body 34 and thus, moved relative to the sensor 86 as the shift lever 12 is moved. In a contact type sensor, a potentiometer or variable resistor may be used (and may be provided on the circuit board 90) and electrical contacts may be carried by shift lever 12 (or vice versa) so that there is relative movement between the variable resistor and the contacts as the shift lever moves to provide a changing resistance as the shift lever moves. The resistance may be sensed and the position of the shift lever 12 determined accordingly. Optical sensors may also be used and easily calibrated to sense the linear movement of the shift lever 12. Further, the guided, substantially linear movement of the shift lever may facilitate reliable return of the shift lever to the home position by the actuator, as noted above. Of course, the shift lever sensing arrangement is not limited to the examples provided herein and other arrangements will be apparent in view of this disclosure.

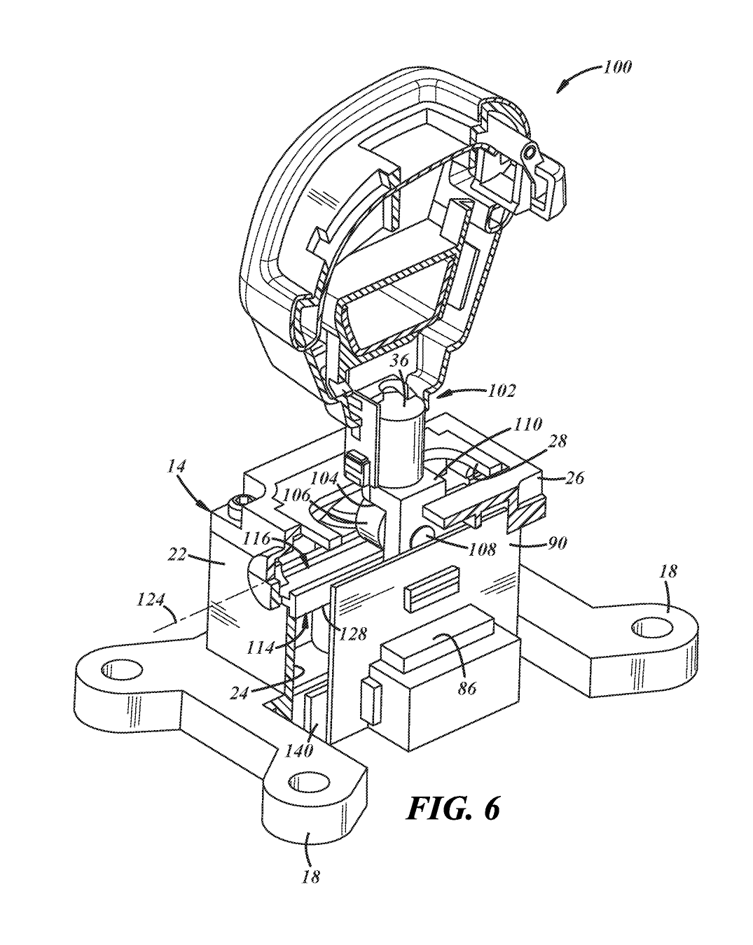

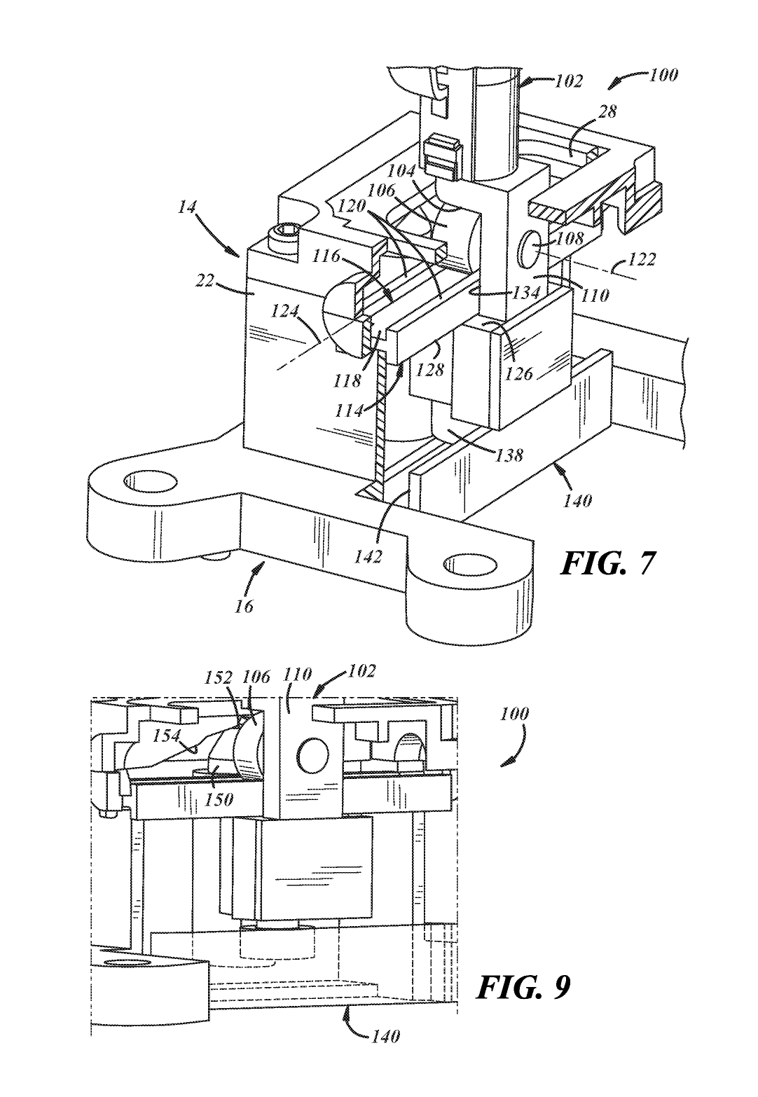

FIGS. 6 and 7 illustrate another implementation of a shift lever assembly 100 which may be similar to the shift lever assembly 10 described above. To facilitate description of this assembly 100, the same reference numbers may be used to denote components that are the same as or similar to components in the assembly 10 described above. Further, the entire assembly 100 will not be described herein and instead, only certain differences will be highlighted.

In the shift lever assembly 100 shown in FIGS. 6 and 7, the shift lever 102 includes an opening or cavity 104 in which a roller 106 is received. The roller 106 may rotate relative to a pin 108 that is coupled to a main body 110 of the shift lever 102 (e.g. screwed, clipped, pressed or otherwise received in an opening of the main body). The first guide 114 may include a track 116, which may be defined in a slot or channel formed in the first guide. The roller 106 may have a width slightly smaller than the width of a base surface 118 of the track 116. In at least some implementations, perpendicular, upstanding flanges 120 may be provided on either side of the base surface 118 to define a generally U-shaped channel. In use, the roller 106 is maintained within the track 116, engaged with the base surface 118 and perhaps guided for linear movement by the flanges 120. The roller 106 rotates relative to the first guide 114 about an axis 122 perpendicular to the axis 124 or a track 116 of the first guide 114 as the shift lever 102 is moved between its various positions to avoid friction associated with relative sliding movement. Thus, the assembly 100 provides a low friction coupling between the shift lever 102 and first guide 114 that may be achieved without bearings or reduced friction bearing surfaces.

In at least some implementations, as shown in FIG. 7, the shift lever 102 may include a guide or stop surface 126 that faces opposite the roller 106 and is received adjacent to an opposite side 128 of the first guide 114 as the track 116. The stop surface 126 may engage the first guide 114 to limit movement of the roller 106 away from the first guide, and limit lifting the shift lever 102 relative to the housing 14 (where lifting is movement in a direction tending to remove the second end of the shift lever from the housing). The roller 106 and stop surface 126 may be provided on opposite sides of the axis 124, and the first guide 114 may be received between the roller and the stop surface.

In at least some implementations, as shown in FIGS. 6-8, the first guide 114 is not circular in cross-section. Hence, the shift lever 102 may include surfaces that are positioned closely adjacent to the first guide 114 to limit rotational movement of the shift lever relative to the first guide. For example, in addition to first and second sides 118, 128 of the first guide 114 (e.g. upper and lower sides that are arranged adjacent to the roller and opposed stop surface 126), the first guide may include opposed third and fourth surfaces 130, 132 (e.g. left and right sides) that are on opposite sides of the track 116 and extend between the first and second sides 118, 128. The shift lever 102 may include side stop surfaces 134 (FIG. 7) that engage the first guide rail 114 if a force tending to rotate the shift lever is applied to the shift lever, to prevent rotation of the shift lever about the axis 124 of the first guide 114. The side stop surfaces 134 may be defined by inner surfaces defined by or in the cavity 104 in the shift lever 102 through which the first guide 114 is received. In at least some implementations, the side stop surfaces 134 and the adjacent third and fourth sides 130, 132 of the first guide 114 may be generally planar.

Additionally or instead, the shift lever 102 may include a second roller 138 and the housing 14 may include a second guide 140 having a surface 142 oriented at a non-zero angle relative to the track. In at least some implementations, the second guide surface 142 is oriented parallel to and radially or laterally offset from the path of movement of a portion of the shift lever 102 and the second roller 138 is arranged to engage the surface 142 to prevent rotation of the shift lever 102 relative to the axis 124 in one direction. Another guide surface 144 may be provided and may be engaged by the roller 138 to prevent rotation of the shift lever 102 relative to the axis 124 in the other direction. As in the previously described shift lever assembly 10, the second guide 140 may include two oppositely facing guide surfaces 142, 144, which may, if desired be defined in a channel coupled to the housing 14, or by opposed surfaces of a slot formed in a wall 20, 22 of the housing. Hence, the shift lever 102 may be constrained against rotation relative to the path of movement of the shift lever, i.e. relative to the axis 124 of the first guide 114. Also, the shift lever 102 may be constrained to substantially linear movement, where, in at least some implementations, substantially linear means within 10 degrees of a straight line.

As shown in FIG. 9, the shift lever assembly 100 may include a coupler or pin 150 carried by the main body 110 of the shift lever 102, such as was described above with regard to coupler 70 in the shift lever assembly 10. The coupler 150 is yieldably biased by a spring so that an end 152 of the coupler is engaged with an inclined cam surface 154. The spring biases the coupler 150 in a direction perpendicular to the direction of travel of the shift lever 102 (whereas the previously described and diagrammatically shown spring 80 (FIG. 2) and optionally an opposed spring act along/parallel to the direction of travel of the shift lever). The cam surface 154 may be carried by or part of the housing 14 and may be angled relative to the path of travel of the shift lever 102 so that the farther the shift lever is moved away from a home position, the further the coupler 150 is displaced against the spring, and the greater the spring force is on the coupler. When the force moving the shift lever 102 is removed from the shift lever, the spring causes the coupler 150 to slide along the cam surface 154 which slides the shift lever 102 back toward or to the home position. Another inclined cam surface 154 may be provided on the opposite side of the home position so that a similar action occurs if the shift lever 102 is moved in the opposite direction. In this way, the shift lever 102 may be monostable, and may return to the home position when shifted in either direction away from the home position. The inclined surface(s) 154 could provide force feedback features (e.g. detents) as well, or such features could be provided elsewhere in the assembly or might not be provided at all, as desired. A similar arrangement can be used with the shift lever assembly 10 described above, if desired.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A vehicle shifter assembly, comprising:
a first guide having an axis;
a shift lever coupled to the first guide for two-way movement of the shift lever along the first guide in a path parallel to the first axis; and
a second guide spaced from the first guide and engageable with the shift lever to limit rotational movement of the shift lever relative to the first guide about the axis.

2. The assembly of claim 1 wherein the shift lever includes a main body with an opening through which the first guide extends.

3. The assembly of claim 1 wherein the second guide includes a first guide surface and a second guide surface that are arranged so that the shift lever engages the first guide surface when the shift lever is acted upon by a force tending to rotate the shift lever in a first direction about the axis, and the shift lever engages the second guide surface when the shift lever is acted upon by a force tending to rotate the shift lever in a second direction about the axis.

4. The assembly of claim 2 which also includes a bearing received between the shift lever and first guide.

5. The assembly of claim 1 wherein the shift lever includes a roller that rolls along the first guide when the shift lever is moved along the path.

6. The assembly of claim 5 wherein the shift lever includes a roller that engages the second guide.

7. The assembly of claim 1 wherein the shift lever includes a roller that engages the second guide.

8. The assembly of claim 3 wherein the first guide surface and second guide surface are both parallel to the axis.

9. The assembly of claim 1 which also includes a position sensor having a sensor positioned adjacent to the shift lever path of movement and a sensed component carried by the shift lever and moved relative to the sensor.

10. The assembly of claim 1 which also includes a housing having an interior in which is received at least part of the shift lever, and wherein the housing includes a plurality of feedback features and a coupler is carried by the shift lever for movement with the shift lever relative to the feedback features, the coupler is responsive to the feedback features to provide force feedback to the shift lever.

11. The assembly of claim 10 wherein the feedback features include a surface having a plurality of peaks and valleys and the coupler engages the surface and the coupler is movable relative to the shift lever in response to movement of the coupler over the peaks and valleys.

12. The assembly of claim 11 wherein the coupler is biased into engagement with the surface that includes the peak and valleys.

13. The assembly of claim 5 wherein the first guide includes a track and the roller moves along the track when the shift lever is moved.

14. The assembly of claim 1 which also includes an actuator that provides a force on the shift lever to return the shift lever to a home position when a force moving the shift lever away from the home position is removed from the shift lever.

15. A vehicle shifter assembly, comprising:
a first guide having an axis;
a shift lever including a first end, a second end, and a coupling feature between the first end and the second end that couples the shift lever to the first guide, the coupling feature overlaps at least a portion of the first guide and permits two-way movement of the shift lever along a path defined by the first guide; and
a second guide spaced from the first guide and engageable with the shift lever, wherein the first guide and coupling feature limit rotation of the shift lever relative to the first guide along a plane including the axis, and the second guide constrains movement of the shift lever relative to the first guide about the axis in a plane perpendicular to the axis.

16. The assembly of claim 15 wherein the coupling feature includes an opening in the shift lever through which at least a portion of the first guide extends.

17. The assembly of claim 15 wherein the shift lever includes a roller that rolls along the first guide when the shift lever is moved along the path.

18. The assembly of claim 17 wherein the shift lever includes a roller that engages the second guide.

19. The assembly of claim 15 wherein the shift lever includes a roller that engages the second guide.

20. The assembly of claim 15 which also includes an actuator that provides a force on the shift lever to return the shift lever to a home position when a force moving the shift lever away from the home position is removed from the shift lever.
